(19) United States
(12) Patent Application Publication
(10) Pub. No.: US 2026/0074283 A1
(43) Pub. Date: Mar. 12, 2026

(54) LITHIUM-ION BATTERY

(71) Applicant: SHENZHEN CAPCHEM TECHNOLOGY CO., LTD., Shenzhen, Guangdong (CN)

(72) Inventors: Yunxian Qian, Shenzhen, Guangdong (CN); Shiguang Hu, Shenzhen, Guangdong (CN); Hongmei Li, Shenzhen, Guangdong (CN); Xiaoxia Xiang, Shenzhen, Guangdong (CN); Zhaohua Zhang, Shenzhen, Guangdong (CN)

(21) Appl. No.: 19/108,454

(22) PCT Filed: Aug. 22, 2023
(86) PCT No.: PCT/CN2023/114144

§ 371 Date: Mar. 4, 2025

(30) Foreign Application Priority Data
Sep. 7, 2022 (CN) 202211091339.8

(51) Int. Cl. H01M 10/0567; H01M 4/02; H01M 4/131; H01M 4/62; H01M 10/0525

(52) U.S. Cl. CPC H01M 10/0567; H01M 4/131; H01M 4/622; H01M 4/623; H01M 10/0525; H01M 2004/021; H01M 2300/0025

(57) ABSTRACT

Provided is a lithium-ion battery, comprising a positive electrode plate, a negative electrode plate and a non-aqueous electrolyte. The positive electrode plate comprises a positive electrode current collector and a positive electrode material layer arranged on the positive electrode current collector, and the positive electrode plate has a resistivity less than or equal to 1500 Ω·cm. The non-aqueous electrolyte comprises a non-aqueous organic solvent, a lithium salt and an additive; the additive comprises at least one cyclic sulfonic acid ester selected from 1,3-propane sultone, 1,4-butane sultone, 1,3-propylene sultone and methylene methane disulfonate; the lithium-ion battery meets the following requirements: 0.3≤m*d/f≤20, 70≤d≤150, 3≤f≤30 and 0.01≤m≤3. The lithium-ion battery forms a relatively stable interfacial film during formation, which is beneficial to improving the structural stability of the positive electrode active material, inhibiting the dissolution of metal ions, and avoiding the consumption and decomposition of non-aqueous electrolyte in the cycle process.

### TECHNICAL FIELD

The present application belongs to the technical field of energy storage devices, and particularly relates to a lithium-ion battery.

### BACKGROUND

Compared to traditional batteries, lithium-ion batteries have numerous advantages, including high working voltage, high energy density, long cycle life, and environmental friendliness. They are currently commonly employed in digital items such as smartphones, tablets, cameras, and so on. With the demand and support of new energy projects in China, the application of lithium-ion batteries is expanding to the domains of energy storage, power grids, and electric cars, indicating a wide range of potential uses for lithium-ion batteries.

Increasing the median operating voltage of battery and increasing the specific discharge capacity of electrode materials are two important means to obtain high specific energy lithium-ion batteries, which require that the solvent, lithium salt and related electrode/electrolyte interface layer in the electrolyte have good chemical, electrochemical and mechanical stability within the working voltage range. However, in the electrolyte system composed of conventional carbonate solvent and lithium salt LiPF₆, the water in the battery will react with lithium salt to generate HF acid, which will damage the passive film of the positive and negative electrodes, especially when the working voltage of the electrode is higher than 4.3 V vs Li/Li⁺, the oxidation stability of the electrolyte is poor, and the lithium salt is easy to decompose to generate acidic corrosive substances at high temperature, resulting in the dissolution of positive transition metal ions. As a result, the electrolyte will undergo oxidative decomposition side reactions on the surface of positive electrode materials, which will worsen the cycle life and bring certain safety hazards. On the other hand, the dissolution of metal ions intensifies the phase transition of the positive electrode material, and the internal stress accumulates, which leads to the amorphization of the material and the collapse and fracture of the structure, thus seriously affecting the adhesion between the positive electrode active material and the current collector or the positive electrode active material, resulting in the powder falling off of the positive electrode plate, which leads to the capacity attenuation and poor dynamic performance of battery.

The above characteristics of lithium-ion battery impose very high requirements for the process of battery electrode plate and electrolyte. Developing a matching electrolyte is compatible electrolyte is an inevitable step toward furthering the commercialization of lithium-ion batteries for electric vehicles and energy storage applications. How to reasonably design the positive electrode plate to achieve a battery with both dynamic performance and other electrochemical performance is a prevalent difficulty in the industry at present.

### SUMMARY OF THE INVENTION

In order to address the issues of passive film decomposition and metal ion dissolution in the existing lithium-ion battery under high working voltage, the present application provides a lithium-ion battery.

The technical solutions adopted by the application to solve the technical problems are as follows.

The application provides a lithium-ion battery, which includes a positive electrode plate, a negative electrode plate and a non-aqueous electrolyte, wherein the positive electrode plate includes a positive electrode current collector and a positive electrode material layer arranged on the positive electrode current collector, and the positive electrode plate has a resistivity less than or equal to 1500 Ω·cm;
wherein the non-aqueous electrolyte includes a non-aqueous organic solvent, a lithium salt and an additive; the additive includes at least one cyclic sulfonic acid ester selected from 1,3-propane sultone, 1,4-butane sultone, 1,3-propylene sultone and methylene methane disulfonate;
the lithium-ion battery meets the following requirements:

$$0.3 \leq m * d / f \leq 20 , 70 \leq d \leq 150 , 3 \leq f \leq 30 and 0.01 \leq m \leq 3 ;$$

where “d” is a thickness of the positive electrode plate, in μm;
“f” is an adhesive force between the positive electrode material layer and the positive electrode current collector, in N/m; and
“m” is a percentage mass content of cyclic sulfonic acid ester in the non-aqueous electrolyte, in %.

Optionally, the lithium-ion battery meets the following requirements:

$$0.6 \leq m * d / f \leq 10 .$$

Optionally, the positive electrode plate has a resistivity of 30 to 500 Ωcm.

Optionally, the thickness (d) of the positive electrode plate is 80-130 μm.

Optionally, the adhesive force (f) between the positive electrode material layer and the positive electrode current collector is 5-20 N/m.

Optionally, the percentage mass content (m) of cyclic sulfonic acid ester in the non-aqueous electrolyte is 0.1%-1.5%.

Optionally, the positive electrode material layer includes a positive electrode active material and a positive electrode binder, and the positive electrode binder is selected from organic polymers, and the organic polymer has a molecular weight of 0.6-1.3 million.

Optionally, the organic polymer includes one or more of polyvinylidene fluoride, polyvinylidene difluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-fluoroethylene copolymer, vinylidene fluoride-hexafluoropropylene-tetrafluoroethylene copolymer, thermoplastic polyimide, non-thermoplastic polyimide, polyethylene, polypropylene, polyethylene glycol terephthalate, polymethyl methacrylate, acrylic resin, carboxymethyl cellulose sodium, nitrile rubber, butadiene styrene rubber, polybutadiene rubber, ethylene-propylene rubber, styrene-butadiene-styrene block copolymer or its hydride, ethylene-propylene-diene terpolymer, polyvinyl acetate, syndiotactic-1,2-polybutadiene and ethylene-vinyl acetate.

Optionally, the positive electrode active material is at least one selected from the group consisting of LiFe_{1-x′}M′_{x′}PO₄, LiMn_{2-y′}M_{y′}O₄ and LiNiₓCo_{y}Mn_{z}M_{1-x-y-z}O₂, where M′ is at least one selected from the group consisting of Mn, Mg, Co, Ni, Cu, Zn, Al, Sn, B, Ga, Cr, Sr, V and Ti; M is at least one selected from the group consisting of Fe, Co, Ni, Mg, Cu, Zn, Al, Sn, B, Ga, Cr, Sr, V and Ti, and 0≤x′<1, 0≤y′≤1, 0≤y≤1, 0≤x≤1, 0≤z≤1 and x+y+z≤1.

Optionally, the additive further includes at least one of cyclic sulfate compounds, cyclic carbonate compounds, phosphate compounds, borate compounds and nitrile compounds.

Optionally, the additive is added in an amount of 0.01%-30% based on the total mass of the non-aqueous electrolyte being 100%.

Preferably, the cyclic sulfate compound is at least one selected from the group consisting of ethylene sulfate, propylene sulfate, methyl ethylene sulfate,

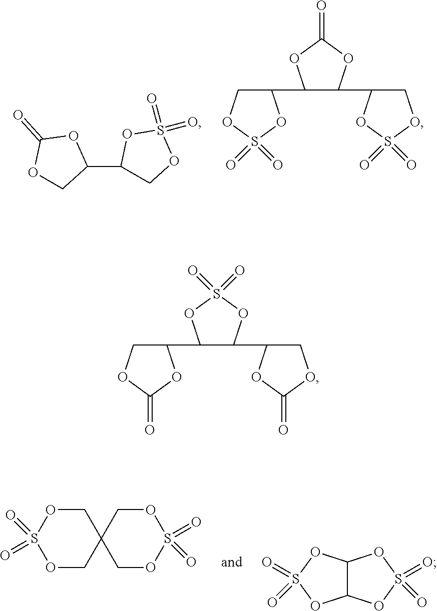

the cyclic carbonate compound is selected from at least one of vinylene carbonate, vinylethylene carbonate, methylene ethylene carbonate, fluoroethylene carbonate, trifluoromethyl ethylene carbonate, bis-fluoroethylene carbonate or a compound represented by structural formula

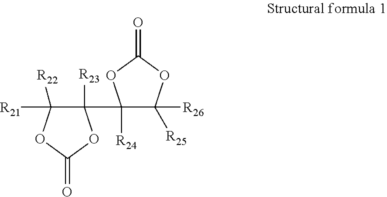

in structural formula 1, R₂₁, R₂₂, R₂₃, R₂₄, R₂₅ and R₂₆ are independently selected from one of a hydrogen atom, a halogen atom and a C1-C5 group;
the phosphate compound is selected from at least one of tri (trimethylsilane) phosphate, tri (trimethylsilane) phosphite or a compound represented by structural formula 2:

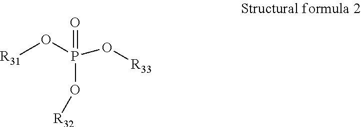

in structural formula 2, R₃₁, R₃₂ and R₃₃ are independently selected from a C1-C5 saturated hydrocarbon group, a C1-C5 unsaturated hydrocarbon group, a C1-C5 halogenated hydrocarbon group and —Si(CₘH₂ₘ₊₁)₃, m is a natural number of 1-3, and at least one of R₃₁, R₃₂ and R₃₃ is an unsaturated hydrocarbon group;
the borate compound is selected from at least one of tris (trimethylsilane) borate and tris (triethyl silicane) borate; and
the nitrile compound is at least one selected from the group consisting of butanedinitrile, glutaronitrile, ethylene glycol bis (propionitrile) ether, hexanetricarbonitrile, adiponitrile, pimelic dinitrile, hexamethylene dicyanide, azelaic dinitrile and sebaconitrile.

According to the lithium-ion battery provided by the application, at least one cyclic sulfonic acid ester selected from 1,3-propane sultone, 1,4-butane sultone, 1,3-propylene sultone and methylene methane disulfonate is added into the non-aqueous electrolyte as an additive, therefore an interfacial film can be formed on the surface of the positive electrode material layer. To address the issue of film decomposition at lower working voltage for the battery, the inventor(s) found through a lot of research that: when the thickness (d) of the positive electrode plate, the adhesive force (f) between the positive electrode material layer and the positive electrode current collector, and the percentage mass content (m) of cyclic sulfonic acid ester in the non-aqueous electrolyte satisfy the relation of 0.3≤m*d/f≤20, the electron conduction rate inside the positive electrode can be improved, and meanwhile, the non-aqueous electrolyte has a sufficient wetting effect on the positive electrode material layer, so that the non-aqueous electrolyte can evenly cover the interface of the positive electrode material layer, and a relatively stable interfacial film can be formed during formation. It is beneficial to improve the structural stability of the positive electrode active material, inhibit the dissolution of metal ions, and effectively separate the non-aqueous electrolyte from the positive electrode material layer to avoid the consumption and decomposition of the non-aqueous electrolyte in the cycle process.

### DETAILED DESCRIPTION OF PREFERRED EMBODIMENTS

In order to make the technical problems, technical solutions and beneficial effects of the present application more clear, the application will be further explained in detail below with embodiments. It should be understood that the specific embodiments described here are only used to illustrate the application, rather than to limit the application.

The embodiment of the application provides a positive electrode plate, a negative electrode plate and a non-aqueous electrolyte, wherein the positive electrode plate includes a positive electrode current collector and a positive electrode material layer arranged on the positive electrode current collector, and the positive electrode plate has a resistivity less than or equal to 1500 Ω·cm;
wherein the non-aqueous electrolyte includes a non-aqueous organic solvent, a lithium salt and an additive; the additive includes at least one cyclic sulfonic acid ester selected from 1,3-propane sultone, 1,4-butane sultone, 1,3-propylene sultone and methylene methane disulfonate;
the lithium-ion battery meets the following requirements:

$$0.3 \leq m * d / f \leq 20 , 70 \leq d \leq 150 , 3 \leq f \leq 30 and 0.01 \leq m \leq 3 ;$$

where “d” is a thickness of the positive electrode plate, in μm;
“f” is an adhesive force between the positive electrode material layer and the positive electrode current collector, in N/m; and
“m” is a percentage mass content of cyclic sulfonic acid ester in the non-aqueous electrolyte, in %.

At least one cyclic sulfonic acid ester selected from 1,3-propane sultone, 1,4-butane sultone, 1,3-propylene sultone and methylene methane disulfonate is added into the non-aqueous electrolyte as an additive, therefore an interfacial film can be formed on the surface of the positive electrode material layer. To address the issue of film decomposition at lower working voltage for the battery, the inventor(s) found through a lot of research that: when the thickness (d) of the positive electrode plate, the adhesive force (f) between the positive electrode material layer and the positive electrode current collector, and the percentage mass content (m) of cyclic sulfonic acid ester in the non-aqueous electrolyte satisfy the relation of 0.3≤m*d/f≤20, the electron conduction rate inside the positive electrode can be improved, and meanwhile, the non-aqueous electrolyte has a sufficient wetting effect on the positive electrode material layer, so that the non-aqueous electrolyte can evenly cover the interface of the positive electrode material layer, and a relatively stable interfacial film can be formed during formation. It is beneficial to improve the structural stability of the positive electrode active material, inhibit the dissolution of metal ions, and effectively separate the non-aqueous electrolyte from the positive electrode material layer to avoid the consumption and decomposition of the non-aqueous electrolyte in the cycle process.

In a preferred embodiment, the lithium-ion battery meets the following requirements:

$$0.6 \leq m * d / f \leq 10 .$$

When the thickness (d) of the positive electrode plate, the adhesive force (f) between the positive electrode material layer and the positive electrode current collector, and the percentage mass content (m) of cyclic sulfonic acid ester in the non-aqueous electrolyte meet the above requirements, a good synergistic effect can be manifested to jointly promote the material stability of the positive electrode material layer and the non-aqueous electrolyte under high working voltage and improve the cycle performance of battery.

In a specific embodiment, the resistivity of the positive electrode plate may be 5 Ω·cm, 10 Ω·cm, 20 Ω·cm, 30 Ω·cm, 40 Ω·cm, 50 Ω·cm, 60 Ω·cm, 80 Ω·cm, 100 Ω·cm, 150 Ω·cm, 200 Ω·cm, 250 Ω·cm, 300 Ω·cm, 400 Ω·cm, 500 Ω·cm, 600 Ω·cm, 700 Ω·cm, 800 Ω·cm, 900 Ω·cm, 1000 Ω·cm, 1200 Ω·cm, 13000 Ω·cm or 1500 Ω·cm.

In a preferred embodiment, the resistivity of the positive electrode plate is 30-500 Ωcm.

In specific embodiments, the thickness (d) of the positive electrode plate may be 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm or 150 μm.

In a preferred embodiment, the thickness (d) of the positive electrode plate is 80-130 μm.

It should be noted that the thickness of the positive electrode plate refers to the thickness of the positive electrode current collector plus the positive electrode material layer on its surface. When the positive electrode material layer on the positive electrode current collector is coated on one side, the thickness of the positive electrode plate is the thickness of a single positive electrode current collector plus the thickness of a single positive electrode material layer. When the positive electrode material layer on the positive electrode current collector is coated on both side, the thickness of the positive electrode plate is the thickness of a single positive electrode current collector plus the thickness of a double-layer positive electrode material layer.

The smaller the thickness of the positive electrode plate is, the easier it is for electrolyte to enter the pores of the positive electrode material layer. The smaller the resistance of lithium-ions from the surface of the positive electrode material layer to the inside of the pores of the positive electrode material layer, the better the dynamic performance of battery. However, the decrease of the thickness of the positive electrode plate will also lead to the decrease of the energy density of battery. The greater the thickness of the positive electrode plate, the longer the lithium-ion transfer channel, which is not conducive to the infiltration of electrolyte, and the lithium-ion battery dynamics will deteriorate. Moreover, it will also affect the adhesion between the positive electrode material layer and the positive electrode current collector and the adhesion between the positive electrode active material particles. In the battery assembly process, the risk of the positive electrode material layer falling off becomes higher, which can have an impact on the improvement effect of battery dynamics and cycle performance, and may even lead to safety accidents. Therefore, when the thickness of the positive electrode plate falls within the above-mentioned preferred range, the dynamic performance of battery can be better improved. In addition, the electrolyte retention capacity of the positive electrode material layer is also better. And the liquid phase conduction impedance of lithium-ion increases slowly, so the cycle performance of battery can be further improved.

In a specific embodiment, the adhesive force (f) between the positive electrode material layer and the positive electrode current collector may be 3 N/m, 4 N/m, 5 N/m, 8 N/m, 10 N/m, 13 N/m, 15 N/m, 16 N/m, 18 N/m, 21 N/m, 23 N/m, 24 N/m, 26 N/m, 27 N/m, 29 N/m or 30 N/m.

In a preferred embodiment, the adhesive force (f) between the positive electrode material layer and the positive electrode current collector is 5-20 N/m.

Too low adhesion between the positive electrode material layer and the positive electrode current collector will affect the electron conduction between the positive electrode material layer and the positive electrode current collector. With the increase of adhesion between the positive electrode material layer and the positive electrode current collector, the better the conductivity of electrons reaching the positive electrode material layer through the positive electrode current collector, the faster the charge exchange speed between active ions and electrons on the surface of the positive electrode active material, and the battery can have better dynamic performance. However, when the adhesive force between the positive electrode material layer and the positive electrode current collector is too strong, there may be too much binder in the positive electrode material layer or too large spreading area of the binder on the surface of the positive electrode active material and the positive electrode current collector, which is not conducive to the electron conduction of the positive electrode and the dynamic performance of battery is even worse. Moreover, the effect of improving the energy density of battery may also be affected by the increase of binder content in the positive electrode material layer.

In a specific embodiment, the percentage mass content (m) of cyclic sulfonic acid ester in the non-aqueous electrolyte is 0.01%, 0.02%, 0.05%, 0.08%, 0.1%, 0.2%, 0.4%, 0.5%, 0.7%, 0.9%, 1.0%, 1.1%, 1.3%, 1.5%, 1.8%, 2.0%, 2.3%, 2.7% or 3.0%.

In a preferred embodiment, the percentage mass content (m) of cyclic sulfonic acid ester in the non-aqueous electrolyte is 0.1%-1.5%.

If the percentage mass content of cyclic sulfonic acid ester in the non-aqueous electrolyte is too low, it will not be conducive to the formation of a stable interfacial film with high ionic conductivity on the surface of the positive electrode material layer, which will lead to the dissolution of metal ions in the positive electrode active material, and the dissolution of metal ions will intensify the phase transition of the positive electrode material, resulting in the accumulation of internal stress, which will lead to the amorphization of the material and the collapse and fracture of the structure. The pulverization failure of the positive electrode material will also affect the adhesion effect between the positive electrode material layer and the positive electrode current collector, resulting in the problem of positive electrode powder dropping, which will lead to the battery capacity attenuation. If the percentage mass content of cyclic sulfonic acid ester in the non-aqueous electrolyte is too high, the formed interfacial film will be too thick, which will increase the impedance of battery. Therefore, when the percentage mass content of cyclic sulfonic acid ester in the non-aqueous electrolyte is within the above range, it will be beneficial to form a stable interfacial film with high ionic conductivity on the surface of the positive electrode material layer, promote the diffusion of lithium-ions, inhibit the metal ion problem of the positive electrode active material and improve the cycle performance of battery.

In some embodiments, the lithium-ion battery is a pouch battery or an ebonite battery.

In some embodiments, the positive electrode material layer includes a positive electrode active material and a positive electrode binder. The positive electrode binder is selected from organic polymers, and the molecular weight of the organic polymers is 0.6-1.3 million.

When the positive electrode binder meets the above requirements, the positive electrode material layer and the positive electrode current collector can have good adhesion and dynamic performance, and the battery can be guaranteed to have excellent capacity and cycle life.

In some embodiments, the organic polymer includes one or more of polyvinylidene fluoride, polyvinylidene difluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-fluoroethylene copolymer, vinylidene fluoride-hexafluoropropylene-tetrafluoroethylene copolymer, thermoplastic polyimide, non-thermoplastic polyimide, polyethylene, polypropylene, polyethylene glycol terephthalate, polymethyl methacrylate, acrylic resin, carboxymethyl cellulose sodium, nitrile rubber, butadiene styrene rubber, polybutadiene rubber, ethylene-propylene rubber, styrene-butadiene-styrene block copolymer or its hydride, ethylene-propylene-diene terpolymer, polyvinyl acetate, syndiotactic-1,2-polybutadiene and ethylene-vinyl acetate.

In some embodiments, the positive electrode material layer further includes an positive electrode conductive agent, which includes one or more of conductive carbon black, conductive carbon balls, conductive graphite, conductive carbon fibers, carbon nanotubes, graphene or reduced graphene oxide.

In some embodiments, the positive electrode active material is at least one selected from the group consisting of LiFe_{1-x′}M′_{x′}PO₄, LiMn_{2-y′}M_{y′}O₄ and LiNiₓCo_{y}Mn_{z}M_{1-x-y-z}O₂, where M′ is at least one selected from the group consisting of Mn, Mg, Co, Ni, Cu, Zn, Al, Sn, B, Ga, Cr, Sr, V and Ti; M is at least one selected from the group consisting of Fe, Co, Ni, Mg, Cu, Zn, Al, Sn, B, Ga, Cr, Sr, V and Ti, and 0≤x′<1, 0≤y′≤1, 0≤y≤1, 0≤x≤1, 0≤z≤1 and x+y+2≤1.

In a preferred embodiment, the positive electrode active material can be at least one selected from the group consisting of LiCoO₂, LiFePO₄, LiFe_{0.8}Mn_{0.2}PO₄, LiMn₂O₄, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, LiNi_{0.5}Co_{0.2}Mn_{0.2}Al_{0.1}O₂ and LiNi_{0.5}Co_{0.2}Al_{0.3}O₂.

In some embodiments, the positive electrode current collector is selected from metal materials that can conduct electrons. Preferably, the positive electrode current collector includes one or more of Al, Ni, tin, copper and stainless steel. In a more preferred embodiment, the positive electrode current collector is selected from aluminum foil.

In some embodiments, the negative electrode includes a negative electrode material layer, which includes a negative electrode active material.

In a preferred embodiment, the negative electrode active material includes at least one of a carbon-based negative electrode, a silicon-based negative electrode, a tin-based negative electrode and a lithium negative electrode. The carbon-based negative electrode may include graphite, hard carbon, soft carbon, graphene, mesophase carbon microspheres, etc. The silicon-based negative electrode may include silicon material, silicon oxide, silicon-carbon composite material, silicon alloy material, etc. The tin-based negative electrode may include tin, tin carbon, tin oxide and tin metal compounds. The lithium negative electrode may include metallic lithium or lithium alloy. The lithium alloy may be at least one of lithium silicon alloy, lithium sodium alloy, lithium potassium alloy, lithium aluminum alloy, lithium tin alloy and lithium indium alloy.

In some embodiments, the negative electrode material layer further includes a negative electrode binder and a negative electrode conductive agent. The negative electrode active material, the negative electrode binder and the negative electrode conductive agent are mixed to obtain the negative electrode material layer.

The possible ranges of the negative electrode binder and the negative electrode conductive agent are the same as those of the positive electrode binder and the positive electrode conductive agent respectively, and the details are not repeated here.

In some embodiments, the negative electrode plate further includes a negative electrode current collector, and the negative electrode material layer is formed on the surface of the negative electrode current collector.

The negative current collector is selected from metal materials that can conduct electrons. Preferably, the negative current collector includes one or more of aluminum, nickel, tin, copper and stainless steel. In a more preferred embodiment, the negative current collector is selected from copper foil.

In some embodiments, the lithium salt includes LiPF₆, LiBOB, LIDFOB, LiPO₂F₂, LiBF₄, LiSbF₆, LiAsF₆, LiN(SO₂CF₃)₂, LiN(SO₂C₂F₅)₂, LiC(SO₂CF₃)₃, LiN(SO₂F)₂, LiClO₄, LiAlCl₄, LiCF₃SO₃, Li₂B₁₀Cl₁₀, LISO₃F, LiTOP, LIDODFP and lithium salts of lower aliphatic carboxylic acids.

In some embodiments, the concentration of the lithium salt in the non-aqueous electrolyte is 0.1 mol/L-8 mol/L. In a preferred embodiment, the concentration of the lithium salt in the non-aqueous electrolyte is 0.5 mol/L-2.5 mol/L. Specifically, the concentration of the lithium salt in the non-aqueous electrolyte may be 0.5 mol/L, 1 mol/L, 1.5 mol/L, 2 mol/L and 2.5 mol/L.

In some embodiments, the non-aqueous organic solvent includes one or more of ether solvent, nitrile solvent, carbonate solvent and carboxylic ester solvent.

In some embodiments, the ether solvent includes cyclic ether or chain ether, preferably chain ether with 3-10 carbon atoms and cyclic ether with 3-6 carbon atoms, and the specific cyclic ether may be but are not limited to 1,3-dioxolane (DOL), 1,4-dioxooxane (DX), crown ether, and tetrahydrofuran (THF), 2-methyltetrahydrofuran (2-CH₃-THF) 2-trifluoromethyltetrahydrofuran (2-CF₃-THF). Specifically, the chain ether may be but not limited to dimethoxymethane, diethoxymethane, ethoxymethoxymethane, ethylene glycol di-n-propyl ether, ethylene glycol di-n-butyl ether and diethylene glycol dimethyl ether. Dimethoxymethane, diethoxymethane and ethoxymethoxymethane with low viscosity and high ionic conductivity arc particularly preferred because the solvability of chain ether and lithium-ions is high and the ion dissociation can be improved. Ether compounds may be used alone or in any combinations and ratios of two or more kinds. The addition amount of ether compound is not particularly limited, which is within the range of not significantly damaging the effect of the high-voltage lithium-ion battery of the present application. In the non-aqueous solvent volume ratio of 100%, the volume ratio is usually 1% or more, preferably 2% or more, more preferably 3% or more. Moreover, the volume ratio is usually 30% or less, preferably 25% or less, and more preferably 20% or less. When two or more ether compounds are used in combination, the total amount of ether compounds only needs to be in the above range. When the addition amount of ether compounds is within the above preferred range, it is easy to ensure the improvement effects of ionic conductivity brought by the increase of lithium-ion dissociation degree and the decrease of viscosity of chain ether. In addition, when the negative electrode active material is a carbon material, the co-intercalation reaction of the chain ether and lithium-ions can be suppressed, so that the input-output characteristics and the charge-discharge rate characteristics can be within an appropriate range.

In some embodiments, the nitrile solvent may be, but is not limited to, one or more of acetonitrile, glutaronitrile and malononitrile.

In some embodiments, the carbonate solvent includes a cyclic carbonate or a chain carbonate. The cyclic carbonate may be but not limited to one or more of ethylene carbonate (EC), propene carbonate (PC), γ-butyrolactone (GBL) and butylene carbonate (BC). The chain carbonate may be but not limited to one or more of dimethyl carbonate (DMC), ethyl methyl carbonate (EMC), diethyl carbonate (DEC) and dipropyl carbonate (DPC). The content of cyclic carbonate is not particularly limited, which is within the range of not significantly damaging the effect of the high-voltage lithium-ion battery of the present application. However, in the case where one is used alone, the minimal content is usually 3% by volume or more, preferably 5% by volume or more, relative to the total amount of the solvent in the non-aqueous electrolyte. With this range, the decrease of conductivity caused by the decrease of the dielectric constant of the non-aqueous electrolyte can be avoided, so the high-current discharge characteristics, the stability with respect to the negative electrode and the cycle characteristics of the non-aqueous electrolyte battery can easily reach a good range. In addition, the maximum content is usually 90% or less by volume, preferably 85% or less by volume, and more preferably 80% or less by volume. With this range, the oxidation/reduction resistance of the non-aqueous electrolyte can be improved, thus contributing to the improvement of the stability during high-temperature storage. The content of the chain carbonate is not particularly limited, but it is usually 15% or more by volume, preferably 20% or more by volume, and more preferably 25% or more by volume, relative to the total amount of the solvent in the non-aqueous electrolyte. In addition, the volume ratio is usually 90% or less, preferably 85% or less, and more preferably 80% or less. By setting the content of the chain carbonate in the above range, the viscosity of the non-aqueous electrolyte can be easily kept with an appropriate range, and the decrease of ionic conductivity can be suppressed, thus contributing to a good range of the output characteristics of the non-aqueous electrolyte battery. When two or more kinds of chain carbonates are used in combination, the total amount of the chain carbonate only needs to be in the above range.

In some embodiments, it is also preferable to use chain carbonates with fluorine atoms (hereinafter referred to as “fluorinated chain carbonates”). The number of fluorine atoms in the fluorinated chain carbonate is not particularly limited as long as it is 1 or more, but it is usually 6 or less, preferably 4 or less. When the fluorinated chain carbonate has multiple fluorine atoms, these fluorine atoms can be bonded to the same carbon or to different carbons. Examples of the fluorinated chain carbonates include fluorinated dimethyl carbonate derivatives, fluorinated ethyl methyl carbonate derivatives and fluorinated diethyl carbonate derivatives.

Carboxylic acid solvent includes cyclic carboxylic ester and/or chain carbonic ester. Examples of cyclic carboxylic ester include one or more of γ-butyrolactone, γ-valerolactone and δ-valerolactone. Examples of chain carbonic ester include one or more of methyl acetate (MA), ethyl acetate (EA), n-propyl acetate (EP), butyl acetate, propyl propionate (PP) and butyl propionate.

In some embodiments, sulfone solvent includes cyclic sulfones and chain sulfones, but preferably, in the case of cyclic sulfones, it is usually a compound with 3-6 carbon atoms, preferably 3-5 carbon atoms; and in the case of chain sulfones, it is usually a compound with 2-6 carbon atoms, preferably 2-5 carbon atoms. The addition amount of the sulfone solvent is not particularly limited, which is within the range of not significantly damaging the effect of the lithium-ion battery of the present application. Compared with the total amount of solvent in non-aqueous electrolyte, the volume ratio is usually 0.3% or more, preferably 0.5% or more, more preferably 1% or more. Moreover, the volume ratio is usually 40% or less, preferably 35% or less, and more preferably 30% or less. When two or more kinds of sulfone solvent are used in combination, the total amount of the sulfone solvents only needs to meet the above range. When the addition amount of sulfone solvent is within the above range, the non-aqueou electrolyte with excellent high-temperature storage stability is easily to be obtained.

In a preferred embodiment, the non-aqueous organic solvent includes at least one of ethylene carbonate, dimethyl carbonate, diethyl carbonate, ethyl methyl carbonate, propylene carbonate, butyl acetate, γ-butyrolactone, propyl propionate, ethyl propionate, ethyl butyrate, methyl acetate, ethyl acetate, ethyl fluoroacetate and fluoroether.

In a preferred embodiment, the non-aqueou solvent is a mixture of cyclic carbonic ester and chain carbonic ester.

In some embodiments, the additive further includes at least one of cyclic sulfate compounds, cyclic carbonate compounds, phosphate compounds, borate compounds and nitrile compounds.

The addition amount of the additive is 0.01%-30% based on the total mass of the non-aqueous electrolyte;

Preferably, cyclic sulfate compound is at least one selected from the group consisting of ethylene sulfate, propylene sulfate, methyl ethylene sulfate,

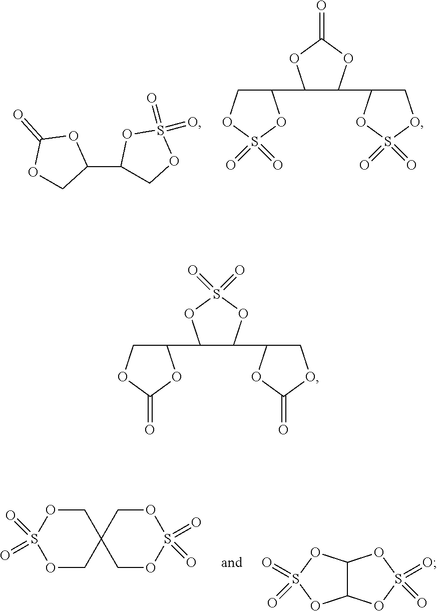

the cyclic carbonate compound is selected from at least one of vinylene carbonate, vinylethylene carbonate, methylene ethylene carbonate, fluoroethylene carbonate, trifluoromethyl ethylene carbonate, bis-fluoroethylene carbonate or a compound represented by structural formula 1.

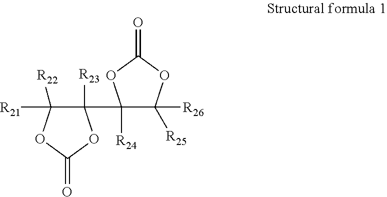

in structural formula 1, R₂₁, R₂₂, R₂₃, R₂₄, R₂₅ and R₂₆ are independently selected from one of a hydrogen atom, a halogen atom and a C1-C5 group; and
the phosphate compound is selected from at least one of tri (trimethylsilane) phosphate, tri (trimethylsilane) phosphite or a compound represented by structural formula 2:

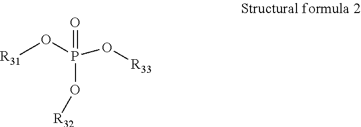

in structural formula 2, R₃₁, R₃₂ and R₃₃ are independently selected from a C1-C5 saturated hydrocarbon group, a C1-C5 unsaturated hydrocarbon group, a C1-C5 halogenated hydrocarbon group and —Si(CₘH₂ₘ₊₁)₃, m is a natural number of 1-3, and at least one of R₃₁, R₃₂ and R₃₃ is an unsaturated hydrocarbon group.

In a preferred embodiment, the phosphate compound represented by structural formula 2 may be at least one selected from the group consisting of phosphoric acid tripropargyl ester, dipropargyl methyl phosphonate, dipropargyl ethyl phosphate, dipropargyl propyl phosphate, dipropargyl trifluoromethyl phosphate, dipropargyl-2, 2, 2-trifluoroethyl phosphate, dipropargyl-3, 3, 3-trifluoropropyl phosphate, dipropargyl hexafluoroisopropyl phosphate, phosphoric acid triallyl ester, diallyl methyl phosphate, diallyl ethyl phosphate, diallyl propyl phosphate, diallyl trifluoromethyl phosphate, diallyl-2, 2, 2-trifluoroethyl phosphate, diallyl-3, 3, 3-trifluoropropyl phosphate or diallyl hexafluoroisopropyl phosphate;
the borate compound is selected from at least one of tris (trimethylsilane) borate and tris (triethyl silicane) borate; and
the nitrile compound is selected from one or more of butanedinitrile, glutaronitrile, ethylene glycol bis (propionitrile) ether, hexanetricarbonitrile, adiponitrile, pimelic dinitrile, hexamethylene dicyanide, azelaic dinitrile and sebaconitrile.

In other embodiments, the additive may also include other additives that can improve the performance of the battery. For example, additives that can improve the safety performance of the battery, flame retardant additives such as fluorophosphate and cyclophosphazene, or overcharge prevention additives such as tert-amylbenzene and tert-butyl benzene.

It should be noted that, unless otherwise specified, in general, the content of any optional substance for the additive in the non-aqueous electrolyte is less than 10%, preferably 0.1-5%, and more preferably 0.1%-2%. Specifically, the content of any optional substance fro the additive may be 0.05%, 0.08%, 0.1%, 0.5%, 0.8%, 1%, 1.2%, 1.5%, 1.8%, 2%, 2.2%, 2.5%, 2.8%, 3%, 3.2%, 3.5%, 3.8%, 4%, 4.5%, 5%, 5.5%, 6%, 6.5%, 7%, 7.5%, 7.8%, 8%, 8.5%, 9%, 9.5% and 10%.

In some embodiments, when the additive is selected from fluoroethylene carbonate, the content of the fluoroethylene carbonate is 0.05%-30% based on the total mass of the non-aqueous electrolyte being 100%.

In some embodiments, the lithium-ion battery also includes a separator, which is positioned between the positive electrode and the negative electrode.

The separator is an existing conventional diaphragm, which may be a ceramic diaphragm, a polymer diaphragm, a nonwoven fabric, an inorganic-organic composite diaphragm, etc. The polymer diaphragm is at least one selected from the group consisting of polyolefins, polyamides, polysulfones, polyphosphazenes, polyethersulfones, polyetheretherketones, polyetheramides and polyacrylonitrile, including but not limited to single-layer PP (polypropylene), single-layer PE (polyethylene), double-layer PP/PE, double-layer PP/PP, triple-layer PP/PE/PP and other diaphragm

In a preferred embodiment, the separator includes a substrate diaphragm and a surface coating. The surface coating is inorganic particles or organic gel or a mixture of the two and is coated on at least one side surface of the substrate diaphragm.

The present application will be further illustrated with embodiments and examples.

The compounds mentioned in the following embodiments and comparative examples are shown in the following Table.

TABLE 1
Parameter Design of Embodiments and Comparative examples

| | | | | | | non-aqueous electrolyte | | | |
|---|---|---|---|---|---|---|---|---|---|
| | | | Thickness | | Adhesive force (f) | | Content of | | |
| | | Types of | of positive | Types and | between negative | | cyclic | Other | |
| Embodiment/ | Types of positive | negative | electrode | molecular | diaphragm and | Cyclic | sulfoni | additives | |
| Comparative | electrode active | active | plate d | weight of | negative current | sulfonic | acid ester | and | |
| example | material | materials | (μm) | binders | collector (N/m) | acid ester | cm/% | contents/% | d/f*m |
| Embodiment 1 | LiNi_{0.8}Mn_{0.1}Co_{0.1}O₂ | Graphite | 100 | Polyvinylidene | 10 | 1,3-propane | 0.5 | / | 5.0 |
| | | | | difluoride: | | sultone | | | |
| | | | | 1.1 million | | | | | |
| Embodiment 2 | LiNi_{0.8}Mn_{0.1}Co_{0.1}O₂ | Graphite | 110 | Polyvinylidene | 15 | 1,3-propane | 0.2 | / | 1.5 |
| | | | | difluoride: | | sultone | | | |
| | | | | 1 million | | | | | |
| Embodiment 3 | LiNi_{0.8}Mn_{0.1}Co_{0.1}O₂ | Graphite | 70 | Polyvinylidene | 12 | 1,3-propane | 0.1 | / | 0.6 |
| | | | | difluoride: | | sultone | | | |
| | | | | 1.2 million | | | | | |
| Embodiment 4 | LiNi_{0.8}Mn_{0.1}Co_{0.1}O₂ | Graphite | 150 | Polyvinylidene | 8 | 1,3-propane | 1 | / | 18.8 |
| | | | | difluoride: | | sultone | | | |
| | | | | 1.3 million | | | | | |
| Embodiment 5 | LiNi_{0.8}Mn_{0.1}Co_{0.1}O₂ | Graphite | 80 | Polyvinylidene | 5 | 1,3-propane | 0.6 | / | 9.6 |
| | | | | difluoride: | | sultone | | | |
| | | | | 0.7 million | | | | | |
| Embodiment 6 | LiNi_{0.8}Mn_{0.1}Co_{0.1}O₂ | Graphite | 85 | Polyvinylidene | 4 | 1,3-propane | 0.8 | / | 17.0 |
| | | | | difluoride: | | sultone | | | |
| | | | | 0.8 million | | | | | |
| Embodiment 7 | LiNi_{0.8}Mn_{0.1}Co_{0.1}O₂ | Graphite | 130 | Polyvinylidene | 30 | 1,3-propane | 3 | / | 13.0 |
| | | | | difluoride: | | sultone | | | |
| | | | | 0.9 million | | | | | |
| Embodiment 8 | LiNi_{0.8}Mn_{0.1}Co_{0.1}O₂ | Graphite | 90 | Polyvinylidene | 20 | 1,3-propane | 1.5 | / | 6.8 |
| | | | | difluoride: | | sultone | | | |
| | | | | 0.6 million | | | | | |
| Embodiment 9 | LiNi_{0.8}Mn_{0.1}Co_{0.1}O₂ | Graphite | 145 | Polyvinylidene | 4 | 1,3-propane | 0.01 | / | 0.4 |
| | | | | difluoride: | | sultone | | | |
| | | | | 0.95 | | | | | |
| Embodiment | LiNi_{0.8}Mn_{0.1}Co_{0.1}O₂ | Graphite | 120 | Polyvinylidene | 13 | 1,3-propane | 0.9 | / | 8.3 |
| 10 | | | | difluoride: | | sultone | | | |
| | | | | 0.8 million | | | | | |
| Embodiment | LiNi_{0.8}Mn_{0.1}Co_{0.1}O₂ | Graphite | 140 | Polyvinylidene | 25 | 1,3-propane | 2.5 | / | 14.0 |
| 11 | | | | difluoride: | | sultone | | | |
| | | | | 0.85 | | | | | |
| Embodiment | LiNi_{0.8}Mn_{0.1}Co_{0.1}O₂ | Graphite | 100 | Polyvinylidene | 5 | 1,3-propane | 0.5 | / | 10.0 |
| 12 | | | | difluoride: | | sultone | | | |
| | | | | 0.7 million | | | | | |
| Embodiment | LiNi_{0.8}Mn_{0.1}Co_{0.1}O₂ | Graphite | 100 | Polyvinylidene | 8 | 1,3-propane | 0.5 | / | 6.3 |
| 13 | | | | difluoride: | | sultone | | | |
| | | | | 0.9 million | | | | | |
| Embodiment | LiNi_{0.8}Mn_{0.1}Co_{0.1}O₂ | Graphite | 100 | Polyvinylidene | 20 | 1,3-propane | 0.5 | / | 2.5 |
| 14 | | | | difluoride: | | sultone | | | |
| | | | | 1.3 million | | | | | |
| Embodiment | LiNi_{0.8}Mn_{0.1}Co_{0.1}O₂ | Graphite | 100 | Polyvinylidene | 10 | 1,3-propane | 0.5 | VC: 1 | 5.0 |
| 15 | | | | difluoride: | | sultone | | | |
| | | | | 1.1 million | | | | | |
| Embodiment | LiNi_{0.8}Mn_{0.1}Co_{0.1}O₂ | Graphite | 100 | Polyvinylidene | 10 | 1,3-propane | 0.5 | FEC: 1 | 5.0 |
| 16 | | | | difluoride: | | sultone | | | |
| | | | | 1.1 million | | | | | |
| Embodiment | LiNi_{0.8}Mn_{0.1}Co_{0.1}O₂ | Graphite | 100 | Polyvinylidene | 10 | 1,3-propane | 0.5 | TMSB: 0.5 | 5.0 |
| 17 | | | | difluoride: | | sultone | | | |
| | | | | 1.1 million | | | | | |
| Embodiment | LiNi_{0.8}Mn_{0.1}Co_{0.1}O₂ | Graphite | 100 | Polytetrafluoro- | 8 | 1,3-propane | 0.5 | / | 6.3 |
| 18 | | | | ethylene: | | sultone | | | |
| | | | | 1 million | | | | | |
| Embodiment | LiNi_{0.8}Mn_{0.1}Co_{0.1}O₂ | Graphite | 100 | Polymethyl- | 9 | 1,3-propane | 0.5 | / | 5.6 |
| 19 | | | | methacrylate: | | sultone | | | |
| | | | | 0.8 million | | | | | |
| Embodiment | LiNi_{0.8}Mn_{0.1}Co_{0.1}O₂ | Graphite | 100 | Non- | 12 | 1,3-propane | 0.5 | / | 4.2 |
| 20 | | | | thermoplastic | | sultone | | | |
| | | | | polyimide: | | | | | |
| | | | | 0.8 million | | | | | |
| Embodiment | LiNi_{0.8}Mn_{0.1}Co_{0.1}O₂ | Graphite | 100 | Ethylene- | 14 | 1,3-propane | 0.5 | / | 3.6 |
| 21 | | | | propylene- | | sultone | | | |
| | | | | diene | | | | | |
| | | | | terpolymer: | | | | | |
| | | | | 0.9 million | | | | | |
| Embodiment | LiNi_{0.8}Mn_{0.1}Co_{0.1}O₂ | Graphite | 100 | :1.1 million | 16 | 1,3-propane | 0.5 | / | 3.1 |
| 22 | | | | | | sultone | | | |
| Embodiment | LiNi_{0.8}Mn_{0.1}Co_{0.1}O₂ | Graphite | 100 | Butadiene | 5 | 1,3-propane | 0.5 | / | 10.0 |
| 23 | | | | styrene | | sultone | | | |
| | | | | rubber: 0.7 | | | | | |
| | | | | million | | | | | |
| Embodiment | LiNi_{0.8}Mn_{0.1}Co_{0.1}O₂ | Graphite | 100 | Polyvinylidene | 10 | 1,3-propane | 0.5 | / | 5.0 |
| 24 | | and SiO₂ | | difluoride: | | sultone | | | |
| | | are | | 1.1 million | | | | | |
| | | mixed in | | | | | | | |
| | | a mass | | | | | | | |
| | | ratio of | | | | | | | |
| | | 9:1 | | | | | | | |
| Embodiment | LiNi_{0.8}Mn_{0.1}Co_{0.1}O₂ | Graphite | 100 | Polyvinylidene | 10 | 1,3-propane | 0.5 | / | 5.0 |
| 25 | | and SiO₂ | | difluoride: | | sultone | | | |
| | | are | | 1.1 million | | | | | |
| | | mixed in | | | | | | | |
| | | a mass | | | | | | | |
| | | ratio of | | | | | | | |
| | | 8:2 | | | | | | | |
| Embodiment | LiNi_{0.8}Mn_{0.1}Co_{0.1}O₂ | Graphite | 100 | Polyvinylidene | 10 | 1,3-propane | 0.5 | / | 5.0 |
| 26 | | and SiO₂ | | difluoride: | | sultone | | | |
| | | are | | 1.1 million | | | | | |
| | | mixed in | | | | | | | |
| | | a mass | | | | | | | |
| | | ratio of | | | | | | | |
| | | 7:3 | | | | | | | |
| Embodiment | LiNi_{0.5}Mn_{0.3}Co_{0.2}O₂ | Graphite | 100 | Polyvinylidene | 10 | 1,3-propane | 0.5 | / | 5.0 |
| 27 | | | | difluoride: | | sultone | | | |
| | | | | 1.1 million | | | | | |
| Embodiment | LiNi_{0.6}Mn_{0.2}Co_{0.2}O₂ | Graphite | 100 | Polyvinylidene | 10 | 1,3-propane | 0.5 | / | 5.0 |
| 28 | | | | difluoride: | | sultone | | | |
| | | | | 1.1 million | | | | | |
| Embodiment | LiNi_{0.7}Mn_{0.2}Co_{0.1}O₂ | Graphite | 100 | Polyvinylidene | 10 | 1,3-propane | 0.5 | / | 5.0 |
| 29 | | | | difluoride: | | sultone | | | |
| | | | | 1.1 million | | | | | |
| Embodiment | LiNi_{0.75}Mn_{0.25}O₂ | Graphite | 100 | Polyvinylidene | 10 | 1,3-propane | 0.5 | / | 5.0 |
| 30 | | | | difluoride: | | sultone | | | |
| | | | | 1.1 million | | | | | |
| Embodiment | LiCoO₂ | Graphite | 100 | Polyvinylidene | 10 | 1,3-propane | 0.5 | / | 5.0 |
| 31 | | | | difluoride: | | sultone | | | |
| | | | | 1.1 million | | | | | |
| Embodiment | LiNi_{0.5}Mn_{1.5}O₄ | Graphite | 100 | Polyvinylidene | 10 | 1,3-propane | 0.5 | / | 5.0 |
| 32 | | | | difluoride: | | sultone | | | |
| | | | | 1.1 million | | | | | |
| Embodiment | LiFePO₄ | Graphite | 100 | Polyvinylidene | 10 | 1,3-propane | 0.5 | / | 5.0 |
| 33 | | | | difluoride: | | sultone | | | |
| | | | | 1.1 million | | | | | |
| Embodiment | LiMn_{0.7}Fe_{0.3}PO₄ | Graphite | 100 | Polyvinylidene | 10 | 1,3-propane | 0.5 | / | 5.0 |
| 34 | | | | difluoride: | | sultone | | | |
| | | | | 1.1 million | | | | | |
| Embodiment | LiNi_{0.8}Mn_{0.1}Co_{0.1}O₂ | Graphite | 100 | Polyvinylidene | 10 | 1,4-butane | 0.5 | / | 5.0 |
| 35 | | | | difluoride: | | sultone | | | |
| | | | | 1.1 million | | | | | |
| Embodiment | LiNi_{0.8}Mn_{0.1}Co_{0.1}O₂ | Graphite | 100 | Polyvinylidene | 10 | 1,3- | 0.5 | / | 5.0 |
| 36 | | | | difluoride: | | propylene | | | |
| | | | | 1.1 million | | sultone | | | |
| Embodiment | LiNi_{0.8}Mn_{0.1}Co_{0.1}O₂ | Graphite | 100 | Polyvinylidene | 10 | Methylene | 0.5 | / | 5.0 |
| 37 | | | | difluoride: | | methanedi- | | | |
| | | | | 1.1 million | | sulfonate | | | |
| Comparative | LiNi_{0.8}Mn_{0.1}Co_{0.1}O₂ | Graphite | 100 | Polyvinylidene | 10 | / | / | / | / |
| example 1 | | | | difluoride: | | | | | |
| | | | | 1.1 million | | | | | |
| Comparative | LiNi_{0.8}Mn_{0.1}Co_{0.1}O₂ | Graphite | 100 | Polyvinylidene | 10 | / | / | VC: 1 | / |
| example 2 | | | | difluoride: | | | | | |
| | | | | 1.1 million | | | | | |
| Comparative | LiNi_{0.8}Mn_{0.1}Co_{0.1}O₂ | Graphite | 100 | Polyvinylidene | 10 | / | / | FEC: 1 | / |
| example 3 | | | | difluoride: | | | | | |
| | | | | 1.1 million | | | | | |
| Comparative | LiNi_{0.8}Mn_{0.1}Co_{0.1}O₂ | Graphite | 100 | Polyvinylidene | 10 | / | / | TMSB: 0.5 | / |
| example 4 | | | | difluoride: | | | | | |
| | | | | 1.1 million | | | | | |
| Comparative | LiNi_{0.8}Mn_{0.1}Co_{0.1}O₂ | Graphite | 65 | Polyvinylidene | 15 | 1,3-propane | 0.5 | / | 2.2 |
| example 5 | | | | difluoride: | | sultone | | | |
| | | | | 1.1 million | | | | | |
| Comparative | LiNi_{0.8}Mn_{0.1}Co_{0.1}O₂ | Graphite | 160 | Polyvinylidene | 18 | 1,3-propane | 0.5 | / | 4.4 |
| example 6 | | | | difluoride: | | sultone | | | |
| | | | | 1.1 million | | | | | |
| Comparative | LiNi_{0.8}Mn_{0.1}Co_{0.1}O₂ | Graphite | 80 | Polyvinylidene | 2 | 1,3-propane | 0.5 | / | 20.0 |
| example 7 | | | | difluoride: | | sultone | | | |
| | | | | 1.1 million | | | | | |
| Comparative | LiNi_{0.8}Mn_{0.1}Co_{0.1}O₂ | Graphite | 90 | Polyvinylidene | 35 | 1,3-propane | 0.5 | / | 1.3 |
| example 8 | | | | difluoride: | | sultone | | | |
| | | | | 1.1 million | | | | | |
| Comparative | LiNi_{0.8}Mn_{0.1}Co_{0.1}O₂ | Graphite | 125 | Polyvinylidene | 5 | 1,3-propane | 0.008 | / | 0.2 |
| example 9 | | | | difluoride: | | sultone | | | |
| | | | | 1.1 million | | | | | |
| Comparative | LiNi_{0.8}Mn_{0.1}Co_{0.1}O₂ | Graphite | 90 | Polyvinylidene | 20 | 1,3-propane | 3.5 | / | 15.8 |
| example 10 | | and SiO₂ | | difluoride: | | sultone | | | |
| | | are | | 1.1 million | | | | | |
| | | mixed in | | | | | | | |
| | | a mass | | | | | | | |
| | | ratio of | | | | | | | |
| | | 8:2 | | | | | | | |
| Comparative | LiNi_{0.8}Mn_{0.1}Co_{0.1}O₂ | Graphite | 130 | Polyvinylidene | 10 | 1,3-propane | 2 | / | 26.0 |
| example 11 | | | | difluoride: | | sultone | | | |
| | | | | 1.1 million | | | | | |
| Comparative | LiNi_{0.8}Mn_{0.1}Co_{0.1}O₂ | Graphite | 80 | Polyvinylidene | 25 | 1,3-propane | 0.05 | / | 0.2 |
| example 12 | | | | difluoride: | | sultone | | | |
| | | | | 1.1 million | | | | | |
| Comparative | LiNi_{0.8}Mn_{0.1}Co_{0.1}O₂ | Graphite | 75 | Polyvinylidene | 30 | 1,3-propane | 0.1 | / | 0.3 |
| example 13 | | | | difluoride: | | sultone | | | |
| | | | | 1.1 million | | | | | |
| Comparative | LiNi_{0.8}Mn_{0.1}Co_{0.1}O₂ | Graphite | 70 | Polyvinylidene | 27 | 1,3-propane | 0.06 | / | 0.2 |
| example 14 | | | | difluoride: | | sultone | | | |
| | | | | 1.1 million | | | | | |
| Comparative | LiNi_{0.8}Mn_{0.1}Co_{0.1}O₂ | Graphite | 120 | Polyvinylidene | 15 | 1,3-propane | 3 | / | 24.0 |
| example 15 | | | | difluoride: | | sultone | | | |
| | | | | 1.1 million | | | | | |
| Comparative | LiNi_{0.8}Mn_{0.1}Co_{0.1}O₂ | Graphite | 130 | Polyvinylidene | 16 | 1,3-propane | 4 | / | 32.5 |
| example 16 | | | | difluoride: | | sultone | | | |
| | | | | 1.1 million | | | | | |
| Comparative | LiNi_{0.8}Mn_{0.1}Co_{0.1}O₂ | Graphite | 100 | Polyvinylidene | 25 | 1,3-propane | 0.5 | / | 2.0 |
| example 17 | | | | difluoride: | | sultone | | | |
| | | | | 1.4 million | | | | | |
| Comparative | LiNi_{0.8}Mn_{0.1}Co_{0.1}O₂ | Graphite | 80 | Polyvinylidene | 2 | 1,3-propane | 0.5 | / | 20.0 |
| example 18 | | | | difluoride: | | sultone | | | |
| | | | | 0.5 million | | | | | |
| Comparative | LiNi_{0.5}Mn_{0.3}Co_{0.2}O₂ | Graphite | 155 | Polyvinylidene | 3 | 1,3-propane | 1 | / | 51.7 |
| example 19 | | | | difluoride: | | sultone | | | |
| | | | | 1.1 million | | | | | |
| Comparative | LiNi_{0.75}Mn_{0.25}O₂ | Graphite | 110 | Polyvinylidene | 5 | 1,3-propane | 1.5 | / | 33.0 |
| example 20 | | | | difluoride: | | sultone | | | |
| | | | | 1.1 million | | | | | |
| Comparative | LiCoO₂ | Graphite | 80 | Polyvinylidene | 18 | 1,3-propane | 0.03 | / | 0.1 |
| example 21 | | | | difluoride: | | sultone | | | |
| | | | | 1.1 million | | | | | |
| Comparative | LiFePO₄ | Graphite | 75 | Polyvinylidene | 35 | 1,3-propane | 0.08 | / | 0.1 |
| example 22 | | | | difluoride: | | sultone | | | |
| | | | | 1.1 million | | | | | |

### Embodiment 1

This embodiment illustrate the invention by taking the preparation of a lithium-ion battery as an example, which includes the following steps:

### 1) Preparation of Non-Aqueous Electrolyte

Ethylene carbonate (EC), diethyl carbonate (DEC) and ethyl methyl carbonate (EMC) were mixed according to the mass ratio of EC:DEC:EMC=1:1:1, and then lithium hexafluorophosphate (LiPF₆) was added until the molar concentration was 1 mol/L, and then 1,3-propane sultone. The content of 1,3-propane sultone in the non-aqueous electrolyte is shown in Table 1 based on the total mass of the non-aqueous electrolyte being 100%

### 2) Preparation of Positive Electrode Plate

The positive electrode active materials of LiNi_{0.8}Co_{0.1}Mn_{0.1}O₂, conductive carbon black Super-P and positive electrode binder were mixed, then they were dispersed in N-methyl-2-pyrrolidone (NMP) to obtain a positive electrode slurry. The aluminum foil was used as a positive electrode current collector. The slurry was evenly coated on both sides of aluminum foil, dried, calendered and vacuum-dried to obtain a positive electrode material layer. A positive electrode plate was obtained by welding aluminum lead wires with an ultrasonic welder. The thickness of the positive electrode plate, the option of the positive electrode binder and molecular weight are shown in Table 1.

The adhesive force between the positive electrode material layer and the positive electrode current collector was tested as follows. The adhesive force between the positive electrode plate and the positive electrode current collector can refer to the national standard GB/T2790-1995 adhesive, 180″ peel strength test method. In the specific test, the High-speed tensile testing machine can be used to test the 180° peel strength at the peeling speed of 50 mm/min, and the average peeling strength collected when the positive electrode plate with a length of 60 mm is completely peeled from the positive electrode current collector is taken as the adhesive force between the positive electrode plate and the positive electrode current collector. The test results are shown in Table 1.

### 3) Preparation of Negative Electrode Plate

The negative electrode active materials of artificial Graphite, conductive carbon black Super-P, binder styrene-butadiene rubber (SBR) and carboxymethyl cellulose (CMC) were mixed according to the mass ratio of 94:1:2.5:2.5, then they were dispersed in deionized water to obtain a negative electrode slurry. The slurry was evenly coated on both sides of copper foil, dried, calendered and vacuum-dried. A negative electrode plate was obtained by welding nickel lead wires with an ultrasonic welder, with a thickness of 120-150 μm.

### 4) Preparation of Battery Core

A three-layer separator with a thickness of 20 μm was placed between the positive electrode plate and the negative electrode plate. The sandwich structure consisting of the positive electrode plate, negative electrode plate and separator was wound, and then the wound body was put into an aluminum foil packaging bag and baked in vacuum at 85° C. for 48 h to obtain a battery core to be injected with liquid.

### 5) Injection and Formation of Battery Core

In a glove box with the dew point controlled below −40° C., the prepared non-aqueous electrolyte was injected into the battery core, and then it was packed and sealed in vacuum condition and let stand for 24 hours.

Then, formation of the first charge was performed according to the following steps: charging at 0.1C constant current for 45 min, charging at 0.2C constant current for 30 min, sealing in vacuum condition for the second time, further charging at 0.5C constant current to 4.2V, then charging at constant voltage until the current dropped to 0.02 C. And after standing for 5 min, discharging at constant current at 0.5C to 3.0V to obtain a LiNi_{0.8}Co_{0.1}Mn_{0.1}O₂/artificial graphite lithium-ion battery.

### Embodiments 2-37

Embodiments 2-37 are used to illustrate the lithium-ion battery and preparation method disclosed in the present application, including most of the steps in Embodiment 1, with the following differences:
the additive, negative electrode active material, plate thickness of the positive electrode material layer, option and molecular weight of the positive electrode binder, and adhesive force between the positive electrode material layer and the positive electrode current collector adopted in Embodiments 2-37 are shown in Table 2.

### Comparative Examples 1-22

Comparative examples 1-22 are used to comparatively illustrate the lithium-ion battery and preparation method disclosed in the present invention, including most of the steps in Embodiment 1, with the following differences:
the additive, negative electrode active material, plate thickness of the positive electrode material layer, option and molecular weight of the positive electrode binder, and adhesive force between the positive electrode material layer and the positive electrode current collector adopted in Comparative examples 1-22 are shown in Table 2.

### Performance Test

The following performance tests were conducted on the lithium-ion battery prepared above. Resistivity test of positive electrode.

The resistance R of the positive electrode plate was tested using an internal resistance tester (HIOKI BT3562), including: cutting the positive electrode plate into a test sample with the size of 10 cm×10 cm; clamping the upper and lower sides of the test sample between two conductive terminals of the internal resistance tester, applying a certain pressure to fix it, and testing the resistance R of the positive electrode plate. The diameter of the conductive terminal is 14 mm (the cross-sectional area is 153.94 mm²), the applied pressure is 15 MPa-27 MPa, and the sampling time ranges from 5 s to 17 s. Each group consists of 4 positive electrode plate samples. After testing the resistance values of 10 sampling times for each sample, the average value is taken as the resistance value R of the group of positive electrode plates. The resistivity of the positive electrode plate is calculated according to ρ=RS/L, where S is the area of the positive electrode plate and L is the thickness of the positive electrode plate.

### Battery Cycle Performance Test

At 25° C., the lithium-ion batteries prepared from Embodiments and Comparative examples were charged at 1C rate and discharged at 1C rate, and the initial charge/discharge capacities of the battery were recorded. The full-charge and full-discharge cycle test was performed at the cut-off voltage of 3V-4.2V until the capacity of the lithium-ion battery decayed to 80% of the initial capacity, and the number of cycles was recorded.

(1) Test results obtained from Embodiments 1-11 and Comparative examples 1, 5-16 and 19-22 are shown in Table 2.

TABLE 2

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 2 | 1179 | 479 | 999 |
| Embodiment 3 | 1157 | 598 | 960 |
| Embodiment 4 | 1207 | 1055 | 916 |
| Embodiment 5 | 1163 | 446 | 1012 |
| Embodiment 6 | 1175 | 846 | 931 |
| Embodiment 7 | 1189 | 648 | 948 |
| Embodiment 8 | 1168 | 420 | 1018 |
| Embodiment 9 | 1200 | 989 | 924 |
| Embodiment 10 | 1183 | 489 | 1006 |
| Embodiment 11 | 1196 | 735 | 939 |
| Comparative example 1 | 1148 | 1882 | 669 |
| Comparative example 5 | 1152 | 1626 | 782 |
| Comparative example 6 | 1212 | 1678 | 766 |
| Comparative example 7 | 1154 | 1701 | 748 |
| Comparative example 8 | 1160 | 1734 | 736 |
| Comparative example 9 | 1197 | 1754 | 726 |
| Comparative example | 1179 | 1776 | 710 |
| 10 | | | |
| Comparative example | 1182 | 1552 | 816 |
| 11 | | | |
| Comparative example | 1159 | 1668 | 777 |
| 12 | | | |
| Comparative example | 1154 | 1622 | 786 |
| 13 | | | |
| Comparative example | 1151 | 1696 | 772 |
| 14 | | | |
| Comparative example | 1177 | 1532 | 828 |
| 15 | | | |
| Comparative example | 1177 | 1578 | 799 |
| 16 | | | |
| Comparative example | 1082 | 1793 | 1034 |
| 19 | | | |
| Comparative example | 1107 | 1607 | 935 |
| 20 | | | |
| Comparative example | 1123 | 1704 | 988 |
| 21 | | | |
| Comparative example | 1019 | 1685 | 1332 |
| 22 | | | |

From the test results of Embodiments 1-11 and Comparative examples 1, 5-16 and 19-22, it can be seen that when cyclic sulfonic acid ester is added into the non-aqueous electrolyte, and the thickness (d) of the positive electrode plate, the adhesive force (f) between the positive electrode material layer and the positive electrode current collector, and the percentage mass content (m) of cyclic sulfonic acid ester in the non-aqueous electrolyte satisfy the relations of 0.3≤m*d/f≤20, 70≤d≤150, 3≤f≤30 and 0.01≤m≤3, the obtained lithium-ion battery has higher initial capacity, lower resistivity and better cycle performance. It is speculated that under the above-mentioned conditions of “the thickness of the positive electrode plate” and “the adhesive force between the positive electrode material layer and the positive electrode current collector”, the electron conduction rate inside the positive electrode can be improved. Meanwhile, the non-aqueous electrolyte has a sufficient wetting effect on the positive electrode material layer to ensure an uniform coverage of the non-aqueous electrolyte on the interface of the positive electrode material layer. Moreover, the cyclic sulfonic acid ester forms a stable and thin interfacial film on the surface of the positive electrode material layer, which is beneficial to improving the structural stability of the positive electrode active material, inhibiting the dissolution of metal ions, effectively separating the non-aqueous electrolyte from the positive electrode material layer, and avoiding the consumption and decomposition of the non-aqueous electrolyte in the cycle process.

According to the test results of Embodiments 1-11, when the thickness (d) of the positive electrode plate, the adhesive force (f) between the positive electrode material layer and the positive electrode current collector, and the percentage mass content (m) of cyclic sulfonic acid ester in the non-aqueous electrolyte further satisfy the relation of 0.6≤m*d/f≤10, it is beneficial to further reduce the resistivity of the positive electrode and prolong the cycle life of the lithium-ion battery. It is speculated that the interfacial film formed by cyclic sulfonic acid ester can cover the surface of the positive electrode material layer more evenly in this state. The contact resistance between the positive electrode material layer and the positive electrode current collector is low, thus ensuring the ion conductivity and electron conductivity and improving the cycle performance of lithium-ion batteries.

From the test results of Comparative examples 1, 5-16 and 19-22, it can be seen that when the values of d, f or m do not meet their range limits, even if the thickness (d) of the positive electrode plate, the adhesive force (f) between the positive electrode material layer and the positive electrode current collector, and the percentage mass content (m) of cyclic sulfonic acid ester in the non-aqueous electrolyte satisfy the relation of 0.3≤m*d/f≤20, the lithium-ion battery still does not have high initial capacity and cycle performance. This indicates that the values of d, f and m have a strong correlation in improving the performance of lithium-ion batteries. Similarly, when the values of d, f and m meet their range limits, but the m*d/f value does not meet the above preset conditions, the improvement of battery performance is still not obvious.

(2) The test results obtained from Embodiments 1, 12-14 and Comparative examples 17-18 are shown in Table 3.

TABLE 3

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 12 | 1185 | 459 | 1020 |
| Embodiment 13 | 1179 | 408 | 1029 |
| Embodiment 14 | 1165 | 437 | 1024 |
| Comparative example 17 | 1169 | 502 | 845 |
| Comparative example 18 | 1165 | 726 | 837 |

According to the test results of Embodiments 1, 12-14 and Comparative examples 17-18, in the battery system provided by the application, when other influencing factors are consistent, with the increase of the molecular weight of the organic polymer used as the positive electrode binder, the resistance of the positive electrode would first decrease and then increase, and the cycle life of the lithium-ion battery would first increase and then decrease, especially when the molecular weight of the organic polymer is 0.6-1.3 million, the lithium-ion battery would have lower impedance and longer cycle life. This suggests that, under the conditions defined by the invention, the choice of molecular weight of organic polymer can further affect the battery performance, and the choice of positive electrode binder with an appropriate molecular weight is beneficial to reduce the battery impedance and prolong the battery life.

(3) The test results obtained from Embodiments 1, 15-17 and Comparative examples 2-4 are shown in Table 4.

TABLE 4

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 15 | 1186 | 268 | 1050 |
| Embodiment 16 | 1181 | 319 | 1044 |
| Embodiment 17 | 1177 | 365 | 1039 |
| Comparative example 2 | 1162 | 1765 | 716 |
| Comparative example 3 | 1157 | 1798 | 708 |
| Comparative example 4 | 1153 | 1823 | 699 |

According to the test results of Embodiments 1, 15-17 and Comparative examples 2-4, compared with the battery systems of vinylene carbonate (VC), fluoroethylene carbonate (FEC) or tris (trimethylsilane) borate (TMSB), the cyclic sulfonic acid ester provided by the present application can better improve the performance of lithium-ion batteries. Moreover, in the battery system provided by the present application, additional addition of vinylene carbonate (VC), fluoroethylene carbonate (FEC) or tris (trimethylsilane) borate (TMSB) can further reduce the resistivity of the positive electrode and prolong the cycle life of battery. This indicates that the mechanism of improving the battery performance by other additives is different from that of cyclic sulfonic acid ester, and they have complementary effects on the film formation, thus improving the quality of the interfacial film on the surface of the positive electrode material layer.

(4) The test results obtained from Embodiments 1, 18-23 are shown in Table 5.

TABLE 5

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 18 | 1167 | 408 | 1023 |
| Embodiment 19 | 1163 | 427 | 1017 |
| Embodiment 20 | 1159 | 467 | 1009 |
| Embodiment 21 | 1154 | 499 | 997 |
| Embodiment 22 | 1168 | 402 | 1026 |
| Embodiment 23 | 1157 | 482 | 1002 |

From the test results of Embodiments 1 and 18-23, it can be seen that when different types of organic polymers are used as the positive electrode binder, the adhesive force (f) between the positive electrode material layer and the positive electrode current collector will be affected to some extent. However, when other variables, such as the thickness (d) of the positive electrode plate and the percentage mass content (m) of cyclic sulfonic acid ester in the non-aqueous electrolyte, are adjusted to make the value of m*d/f meet the preset conditions of the present application, a lithium-ion battery with better performance can be obtained. This indicates that the battery system provided by the present application is suitable for different positive electrode binders.

(5) The test results obtained from Embodiments 1, 24-26 and Comparative example 10 are shown in Table 6.

TABLE 6

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 24 | 1195 | 405 | 906 |
| Embodiment 25 | 1217 | 432 | 882 |
| Embodiment 26 | 1261 | 461 | 864 |
| Comparative example | 1179 | 1776 | 710 |
| 10 | | | |

From the test results of Embodiments 1, 24-26 and Comparative example 10, it can be seen that when the negative active material is mixed with graphite and silicon oxide in different mass ratios, and the relation defined by the present application is 0.3≤m*d/f≤20, the cycle number of lithium-ion batteries can also be effectively improved. This indicates that the system defined by the present application mainly improves the positive electrode part of lithium-ion, thus the definition of this relation is also applicable to different types of negative electrode materials and their combinations.

(6) The test results obtained from Embodiments 1, 27-34 are shown in Table 7.

TABLE 7

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 27 | 1108 | 393 | 1089 |
| Embodiment 28 | 1121 | 397 | 1063 |
| Embodiment 29 | 1136 | 410 | 1045 |
| Embodiment 30 | 1143 | 407 | 982 |
| Embodiment 31 | 1165 | 404 | 1025 |
| Embodiment 32 | 1049 | 413 | 969 |
| Embodiment 33 | 1064 | 485 | 1452 |
| Embodiment 34 | 1117 | 496 | 1094 |

From the test results of Embodiments 1, 27-34 and Comparative examples 19-22, it can be seen that when different types of positive electrode active materials are used, and the relational expressions of 0.3≤m*d/f≤20, 70≤d≤150, 3≤f≤30 and 0.01≤m≤3 defined by the present application are satisfied, the cycle number of lithium-ion batteries can also be effectively improved. This indicates that the system defined by the present application has improved different systems of the positive electrode of lithium-ion, thus the definition of this relation is also applicable to different types of positive electrode materials and their combinations.

(7) The test results obtained from Embodiments 1, 35-37 are shown in Table 8.

TABLE 8

| | | Resistivity of | |
|---|---|---|---|
| | | positive | Number of |
| Embodiment/ | Initial battery | electrode plate | cycles at |
| Comparative example | capacity (mAh) | (Ω · cm) | 25° C. |
| Embodiment 1 | 1172 | 388 | 1034 |
| Embodiment 35 | 1170 | 392 | 1032 |
| Embodiment 36 | 1167 | 394 | 1030 |
| Embodiment 37 | 1165 | 398 | 1024 |

According to the test results of Embodiments 1, 27-34 and Comparative examples 19-22, for different types of cyclic sulfonic acid esters, when the thickness (d) of the positive electrode plate, the adhesive force (f) between the positive electrode material layer and the positive electrode current collector, and the percentage mass content (m) of cyclic sulfonic acid ester in the non-aqueous electrolyte meet the preset condition of 0.3≤m*d/f≤20, their functions are similar. That is, they all ameliorate the problems of capacity attenuation and insufficient dynamic performance of lithium-ion batteries, which indicates that the relation provided by the present application is applicable to different types of cyclic sulfonic acid esters.

The above are merely the preferred embodiments of this application, and are not intended to limit the application. Any modification, equivalent substitution and improvement made within the spirit and principle of this application shall be included in the protection scope of this application.

1. A lithium-ion battery, comprising a positive electrode plate, a negative electrode plate and a non-aqueous electrolyte, wherein the positive electrode plate comprises a positive electrode current collector and a positive electrode material layer arranged on the positive electrode current collector, and the positive electrode plate has a resistivity less than or equal to 1500 Ω·cm;
wherein the non-aqueous electrolyte comprises a non-aqueous organic solvent, a lithium salt and an additive; the additive comprises at least one cyclic sulfonic acid ester selected from 1,3-propane sultone, 1,4-butane sultone, 1,3-propylene sultone and methylene methane disulfonate;
the lithium-ion battery meets the following requirements:
$$0.3 \leq m * d / f \leq 20 , 70 \leq d \leq 150 , 3 \leq f \leq 30 and 0.01 \leq m \leq 3 ;$$
where “d” is a thickness of the positive electrode plate, in μm;
“f” is an adhesive force between the positive electrode material layer and the positive electrode current collector, in N/m; and
“m” is a percentage mass content of cyclic sulfonic acid ester in the non-aqueous electrolyte, in %.

2. The lithium-ion battery of claim 1, wherein the lithium-ion battery meets the following requirements:
$$0.6 \leq m * d / f \leq 10 .$$

3. The lithium-ion battery of claim 1, wherein the positive electrode plate has a resistivity of 30 to 500 Ωcm.

4. The lithium-ion battery of claim 1, wherein the thickness (d) of the positive electrode plate is 80-130 μm.

5. The lithium-ion battery of claim 1, wherein the adhesive force (f) between the positive electrode material layer and the positive electrode current collector is 5-20 N/m.

6. The lithium-ion battery of claim 1, wherein the percentage mass content (m) of cyclic sulfonic acid ester in the non-aqueous electrolyte is 0.1%-1.5%.

7. The lithium-ion battery of claim 1, wherein the positive electrode material layer comprises a positive electrode active material and a positive electrode binder, and the positive electrode binder is selected from organic polymers, and the organic polymer has a molecular weight of 0.6-1.3 million.

8. The lithium-ion battery of claim 7, wherein the organic polymer comprises one or more of polyvinylidene fluoride, polyvinylidene difluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-fluoroethylene copolymer, vinylidene fluoride-hexafluoropropylene-tetrafluoroethylene copolymer, thermoplastic polyimide, non-thermoplastic polyimide, polyethylene, polypropylene, polyethylene glycol terephthalate, polymethyl methacrylate, acrylic resin, carboxymethyl cellulose sodium, nitrile rubber, butadiene styrene rubber, polybutadiene rubber, ethylene-propylene rubber, styrene-butadiene-styrene block copolymer or its hydride, ethylene-propylene-diene terpolymer, polyvinyl acetate, syndiotactic-1,2-polybutadiene and ethylene-vinyl acetate.

9. The lithium-ion battery of claim 7, wherein the positive electrode active material is at least one selected from the group consisting of LiFe_{1-x′}M′_{x′}PO₄, LiMn_{2-y′}M_{y′}O₄ and LiNiₓCo_{y}Mn_{z}M_{1-x-y-z}O₂, where M′ is at least one selected from the group consisting of Mn, Mg, Co, Ni, Cu, Zn, Al, Sn, B, Ga, Cr, Sr, V and Ti; M is at least one selected from the group consisting of Fe, Co, Ni, Mg, Cu, Zn, Al, Sn, B, Ga, Cr, Sr, V and Ti, and 0≤x′<1, 0≤y′≤1, 0≤y≤1, 0≤x≤1, 0≤z≤1 and x+y+z≤1.

10. The lithium-ion battery of claim 1, wherein the additive further comprises at least one of cyclic sulfate compounds, cyclic carbonate compounds, phosphate compounds, borate compounds and nitrile compounds.

11. The lithium-ion battery of claim 10, wherein the additive is added in an amount of 0.01%-30% based on the total mass of the non-aqueous electrolyte being 100%.

12. The lithium-ion battery of claim 10, wherein cyclic sulfate compound is at least one selected from the group consisting of ethylene sulfate, propylene sulfate, methyl ethylene sulfate,

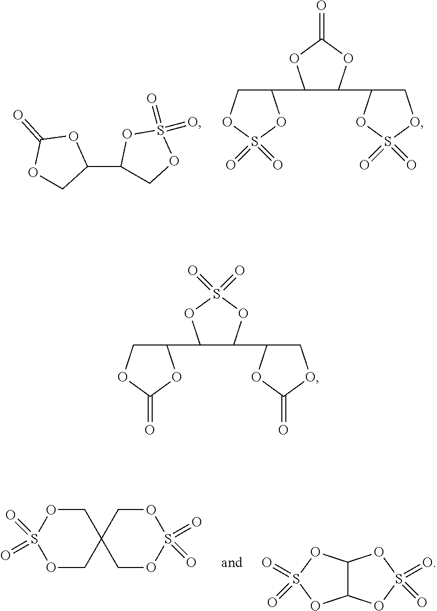

13. The lithium-ion battery of claim 10, wherein the cyclic carbonate compound is selected from at least one of vinylene carbonate, vinylethylene carbonate, methylene ethylene carbonate, fluoroethylene carbonate, trifluoromethyl ethylene carbonate, bis-fluoroethylene carbonate or a compound represented by structural formula 1. 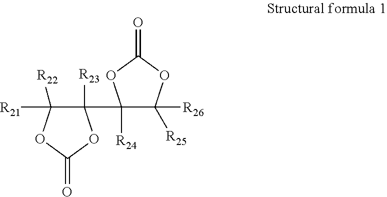
in structural formula 1, R₂₁, R₂₂, R₂₃, R₂₄, R₂₅ and R₂₆ are independently selected from one of a hydrogen atom, a halogen atom and a C1-C5 group.

14. The lithium-ion battery of claim 10, wherein the phosphate compound is selected from at least one of tri (trimethylsilane) phosphate, tri (trimethylsilane) phosphite or a compound represented by structural formula 2: 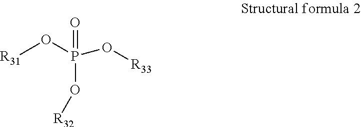
in structural formula 2, R₃₁, R₃₂ and R₃₃ are independently selected from a C1-C5 saturated hydrocarbon group, a C1-C5 unsaturated hydrocarbon group, a C1-C5 halogenated hydrocarbon group and —Si(CₘH₂ₘ₊₁)₃, m is a natural number of 1-3, and at least one of R₃₁, R₃₂ and R₃₃ is an unsaturated hydrocarbon group.

15. The lithium-ion battery of claim 10, wherein the borate compound is selected from at least one of tris (trimethylsilane) borate and tris (triethyl silicane) borate.

16. The lithium-ion battery of claim 10, wherein the nitrile compound is at least one selected from the group consisting of butanedinitrile, glutaronitrile, ethylene glycol bis (propionitrile) ether, hexanetricarbonitrile, adiponitrile, pimelic dinitrile, hexamethylene dicyanide, azelaic dinitrile and sebaconitrile.
